(19) United States
(12) Patent Application Publication
(10) Pub. No.: US 2017/0131820 A1
(43) Pub. Date: May 11, 2017

(54) PRESSURE SENSOR APPARATUS

(71) Applicants: Zhengmin Benjamin Pan, L.A., CA (US); Bingke Zhu, Shenzhen (CN)

(72) Inventors: Zhengmin Benjamin Pan, L.A., CA (US); Bingke Zhu, Shenzhen (CN)

(73) Assignee: AAC Technologies Pte. Ltd., Singapore city (SG)

(21) Appl. No.: 15/297,479

(22) Filed: Oct. 19, 2016

(30) Foreign Application Priority Data
Nov. 10, 2015 (CN) 201520890852.2

(51) Int. Cl. G06F 3/041

(52) U.S. Cl. CPC G06F 3/0414; G06F 3/0416

(57) ABSTRACT

A pressure sensor apparatus is provided. The pressure sensor apparatus includes a bottom plate, a pressing interface opposite to the bottom plate, elastic connectors disposed between the bottom plate and the pressing interface and connecting the bottom plate and the pressing interface, a piezoelectric sheet, a drive member abutted against the piezoelectric sheet and the pressing interface and a processor module. When the pressing interface is pressed, the compression elastic connectors can be deformed; the drive member can transmit the deformation to the piezoelectric sheet so that the piezoelectric sheet can be deformed and then output an electrical signal, and the processor module can calculate the degree of the pressing force exerted onto the pressing interface based on the electrical signal outputted by the piezoelectric sheet and choose corresponding programs based on the association relationship information between the predefined degree of pressing force and the programs.

### FIELD OF THE DISCLOSURE

The present invention relates to a sensor, and in particular relates to a pressure sensor apparatus for portable electronic device.

### BACKGROUND

With the rapid development of science and technology, intelligent portable electronic devices have become more and more popular, such as smart phone, smart bracelet, smart watch, tablet computer and the like. The users not only relentlessly pursue the intelligentization of the portable electronic devices, but also pay more attentions to the rich and colorful experience of using the portable electronic devices.

Therefore, how to realize “user friendly and comfortable” experience of using the portable electronic devices instead of “inflexible and stereotyped” mechanical input and output operations has become a major concern for various manufacturers.

### BRIEF DESCRIPTION OF THE DRAWINGS

Many aspects of the embodiment can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a first pressure sensor apparatus provided by the present intention;

FIG. 2 is a schematic view of the pressure sensor apparatus shown in FIG. 1 when is pressed;

FIG. 3 is a schematic view of a second pressure sensor apparatus provided by the present invention;

FIG. 4 is a schematic view of the pressure sensor apparatus shown in FIG. 3 when is pressed.

### DETAILED DESCRIPTION

The present disclosure will be described in detail below with reference to the attached drawings and the embodiments thereof.

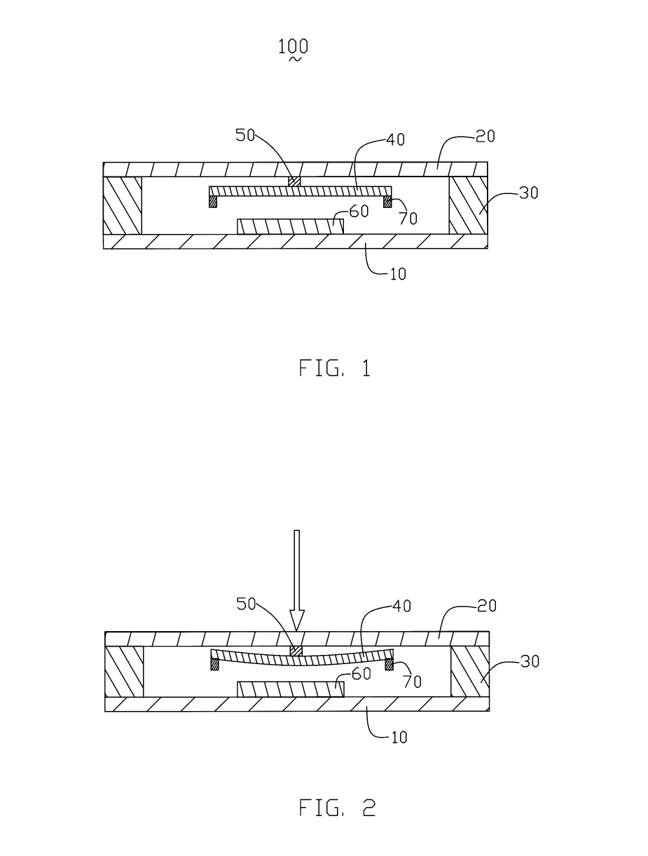

Referring to FIG. 1, a pressure sensor apparatus 100 according to a first exemplary embodiment of the present disclosure is shown. The pressure sensor apparatus 100 comprises a bottom plate 10, a pressing interface 20 opposite to the bottom plate 10, and elastic connectors 30 disposed between the bottom plate 10 and the pressing interface 20 for connecting the bottom plate 10 to the pressing interface 20. The elastic connectors 30 may comprise springs or silicone gaskets. The pressure sensor apparatus 100 further comprises a piezoelectric sheet 40 located under the pressing interface 20, a drive member 50 disposed between the pressing interface 20 and the piezoelectric sheet 40, and a processor module 60. Two ends of the piezoelectric sheet 40 are secured at a fixing part 70 in the pressure sensor apparatus 100. One end of the drive member 50 is abutted against the pressing interface 20, while the other end of the drive member 50 is abutted against the middle portion of the piezoelectric sheet 40.

As shown in FIG. 2, when the pressing interface 20 is pressed by an exterior force, the elastic connectors 30 connected to the pressing interface 20 are forced to be deformed, and displace downwards along a direction of the exterior force. The drive member 50 transmits the downward displacement of the pressing interface 20 to the piezoelectric sheet 40 so that the piezoelectric sheet 40 is deformed and then output an electrical signal. The processor module 60 is used for calculating the degree of the pressing force exerted onto the pressing interface 20 based on the electrical signal outputted by the piezoelectric sheet 40 and choose corresponding programs to execute based on the association relationship information between the predefined degree of pressing force and the programs.

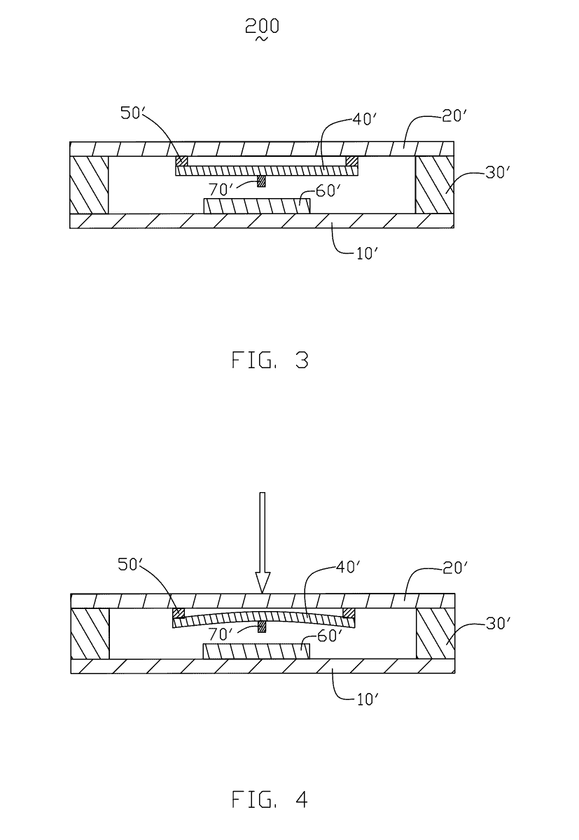

As shown in FIG. 3, a second exemplary pressure sensor apparatus 200 provided by the present invention comprises a bottom plate 10′; a pressing interface 20′ opposite to the bottom plate 10′; and elastic connectors 30′ disposed between the bottom plate 10′ and the pressing interface 20′ for connecting the bottom plate 10′ to the pressing interface 20′. The elastic connectors 30′ may comprise springs or silicone gaskets. The pressure sensor apparatus 200 further comprises a piezoelectric sheet 40′ under the pressing interface 20′; a drive member 50′ disposed between the pressing interface 20′ and the piezoelectric sheet 40′; and a processor module 60. The middle portion of the piezoelectric sheet 400′ is secured at a fixing part 70′ in the pressure sensor apparatus 200. One end of the drive member 50′ is abutted against the pressing interface 20′; the other end of the drive member 50′ is abutted against two ends of the piezoelectric sheet 40′.

As shown in FIG. 4, when the pressing interface 20′ is pressed, the compression elastic connectors 30′ of the pressing interface 20′ is deformed, and displace downwards. The drive member 50′ transmits the downward displacement of the pressing interface 20′ to the piezoelectric sheet 40′ so that the piezoelectric sheet 40′ is deformed and output an electrical signal. The processor module 60′ is used for calculating the degree of the pressing force exerted onto the pressing interface 20′ based on the electrical signal outputted by the piezoelectric sheet 40′ and choose corresponding programs to execute based on the association relationship information between the predefined degree of pressing force and the programs.

The pressing interface 20/20′ can be a screen of a portable electronic device such as a mobile phone, a smart bracelet, a smart watch and a tablet computer and the like. In prior art, the screen of the portable electronic device can only be touched by clicking or sliding operation in order to control it. Based on those functions in prior art, the present invention adds a new function of selecting different programs according to the degree of pressing force exerted onto the screen, which can improve the touch feelings and experiences of the users. Of course, the side frame of the portable electronic device can also be chosen as the pressing interface 20/20′.

The pressure sensor apparatus provided by the present invention not only can improve the touch feelings and experiences of the users, but also can choose different programs based on the degree of the pressing force exerted by the users.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A pressure sensor apparatus, comprising:
a bottom plate;
a pressing interface opposite to the bottom plate;
elastic connectors disposed between the bottom plate and the pressing interface for connecting the bottom plate to the pressing interface;
a piezoelectric sheet;
a drive member abutting against the piezoelectric sheet and the pressing interface; and
a processor module;
wherein when the pressing interface is pressed, the elastic connectors of the pressing interface can be deformed; the drive member can transmit the deformation to the piezoelectric sheet so that the piezoelectric sheet can be deformed and then output an electrical signal;
wherein the processor module can calculate the degree of the pressing force exerted onto the pressing interface based on the electrical signal outputted by the piezoelectric sheet and choose corresponding programs based on the association relationship information between the predefined degree of pressing force and the programs.

2. The pressure sensor apparatus as described in claim 1, wherein when the pressing interface is pressed, the compression elastic connectors of the pressing interface can be deformed, and displace downwards.

3. The pressure sensor apparatus as described in claim 1, wherein the piezoelectric sheet is disposed under the pressing interface and the drive member is disposed between the pressing interface and the piezoelectric sheet.

4. The pressure sensor apparatus as described in claim 3, wherein the pressure sensor apparatus further comprises a fixing part and the piezoelectric sheet is secured onto the fixing part.

5. The pressure sensor apparatus as described in claim 4, wherein two ends of the piezoelectric sheet can be secured at the fixing part; one end of the drive member is abutted against the pressing interface; the other end of the drive member is abutted against the middle portion of the piezoelectric sheet.

6. The pressure sensor apparatus as described in claim 4, wherein the middle portion of the piezoelectric sheet is secured at a fixing part in the pressure sensor apparatus and one end of the drive member is abutted against the pressing interface; the other end of the drive member is abutted against two ends of the piezoelectric sheet.

7. The pressure sensor apparatus as described in claim 1, wherein the elastic connectors are silicone gaskets.

8. The pressure sensor apparatus as described in claim 1, wherein the pressing interface is a screen of the portable electronic device.

9. The pressure sensor apparatus as described in claim 1, wherein the pressing interface is a side frame of the portable electronic device.
